(19) United States
(12) Patent Application Publication
(10) Pub. No.: US 2023/0094849 A1
(43) Pub. Date: Mar. 30, 2023

(54) DISTRIBUTED CRYPTOGRAPHIC NETWORK INTEGRATED WITH CROWD-SOURCED DATABASE

(71) Applicant: Cut and Dry Inc., Woodside, CA (US)

(72) Inventor: Mani KULASOORIYA, Woodside, CA (US)

(21) Appl. No.: 17/952,024

(22) Filed: Sep. 23, 2022

Related U.S. Application Data
(60) Provisional application No. 63/248,850, filed on Sep. 27, 2021.

(51) Int. Cl. G06F 21/10; H04L 9/00

(52) U.S. Cl. CPC G06F 21/10; H04L 9/50

(57) ABSTRACT

A platform that connects a crowd-sourced database (e.g., a Wiki) with a cryptographic blockchain. The crowd-sourced database is a repository of information that is generated and edited by a community of users. Example data in the database includes description or attributes of a set of objects. The cryptographic blockchain interfaces with the crowd-sourced database for purposes of establishing a dictionary of sorts of objects that are logistically tracked (e.g., how many of an object, when a quantity of the object moves from one physical location to another, the physical location of each quantity of the object, costs associated with shifts of the object). Supplying data to the crowd-sourced database and the logistics tracking of items mints new cryptographic tokens. Extracting data from the crowd-sourced database or logistics tracking burns cryptographic tokens.

### TECHNICAL FIELD

The disclosure relates to distributed consensus networks and crowd-sourced databases.

### BACKGROUND

Cryptocurrencies operate on distributed consensus networks that are recorded by blockchain data structures. Some cryptocurrencies include multiple token types and make use of various wallet types to delineate various statuses. Cryptocurrencies are often supported by or recorded on a data structure referred to as a blockchain. Blockchains are immutable, append-only public ledgers. There further exist crowd-sourced informational databases, frequently referred to as “Wiki's.” Wikis are frequently modified by community members and trend toward “truth” by virtue of the utility of truth and community support.

### BRIEF DESCRIPTION OF THE DRAWINGS

FIG. 1 is a flow chart illustrating a method of integrated blockchain actions with crowd-sourced database actions.

FIG. 2 is a block diagram illustrating an application layer and data layer.

FIG. 3 is a block diagram illustrating an overview of an environment 300 in which some implementations of the disclosed technology can operate.

FIG. 4 is a block diagram illustrating a data structure of a smart contract.

### DETAILED DESCRIPTION

Disclosed herein is a platform that connects a crowd-sourced database with a cryptographic blockchain. The crowd-sourced database is a repository of information that is generated and edited by a community of users. Example data in the database includes description or attributes of a set of objects. Such a crowd-sourced database is frequently referred to as a “Wiki.” A Wiki refers to a server program that allows users to collaborate in forming the content of a Web site. The most famous such Wiki is Wikipedia, but there are many other Wikis for numerous purposes. The cryptographic blockchain interfaces with the crowd-sourced database for purposes of establishing a dictionary of sorts of objects that are logistically tracked (e.g., how many of an object, when a quantity of the object moves from one physical location to another, the physical location of each quantity of the object, costs associated with shifts of the object).

The average product in the food supply chain exchanges hands 5 times before it reaches the final buyer. With millions of participants, the industry is fractured, and the relationships between stakeholders are managed by humans in order to guarantee trust between parties. The information exchanged between stakeholders is typically unstructured and is never standardized forcing most of the industry to operate on bad data. A handful of companies have carved out market-making positions among the fragmentation by consolidating enough demand, leading to monopoly-like behavior that rarely aligns with the long-term interests of the food system. The consequences of these factors are significantly higher than necessary food waste, long-distance paths to the customer, system opacity, product unavailability, and higher prices.

The disclosed platform is a global decentralized digital supply chain network that connects all participants in the food ecosystem. While in the broadest sense this includes every living being on the planet (since everyone eats), a rational path to realize this vision lies in creating value for critical participants (Manufacturers, Distributors, Restaurants) before drawing in ancillary stakeholders (Brokers, Consumers, Consultants). The network of the disclosed platform aims to reduce food costs (economic, environmental, and social) while simultaneously increasing food security. This will be done by standardizing the information and decentralizing trust in the supply chain, leading to a more efficient, transparent food system. This vision will be executed in three primary stages.

The disclosed platform digitizes the food ecosystem using an industry standard taxonomy for product and transaction information. Next, incentive models encourage all stakeholders to participate. The enabling technology for this platform makes use of Web 3.0 protocols.

The cryptographic blockchain makes use of tokens that function in a similar manner as “gas” does in Ethereum blockchains but with a more specific set of output cases and use cases. Tokens are spent or burned based on extraction or presentation of the blockchain data (e.g., the logistical tracking of objects). Tokens are generated/minted by a multiple means. One way to mint tokens is to act as a mining node for the blockchain (transaction data). As blocks are generated, tokens are part of the output of the block generation. Another way to generate tokens is to purchase directly from a fiat currency locked stable token.

A third way to mint tokens is to contribute to the Wiki/crowd-sourced database. Not just any submission to the crowd-sourced database is worthy of token rewards. In some embodiments, tokens are awarded for modifications to the crowd-sourced database that persist without subsequent modification for a predetermined period of time (e.g., 24 hours, a few days, a week, etc.). In some embodiments, distinctions are made between introduction of new objects, and edits to previously known objects. In some embodiments, introduction of new objects is worth a greater number of tokens than editing attributes of current objects. In some embodiments, revealing data to the cryptographic blockchain generates tokens as well (e.g., revealing where objects are).

As a general guideline, revealing data to the system generates tokens whereas viewing data from the system costs/burns tokens.

In a given practical example, the above system is implemented on a platform relating to restaurant management and logistics. The objects in the crowd-sourced database are items used by restaurants such as various types of produce, seafood, meats, spices, and consumables. The cryptographic blockchain indicates which producers have which consumables, where distributors are keeping their consumables, and which restaurants order which items and how frequently.

Records that indicate the existence/location of a given object type (e.g., a whole Ahi tuna) via the cryptographic blockchain do not carry any inherent value. The records are similar to database entries, only that the database entries are registered to a blockchain. In some embodiments, the transactions that population the blockchain are generated by an ordering book application. For example, a given restaurant orders goods from a supplier/distributor, and a transaction for those goods is populated in a collective mempool of the cryptographic network for entry to the blockchain by tech patrons/miners.

Some goods records are configured to depopulate (e.g., be consumed) automatically based on a predetermined perishable time or based on a subsequent order of the same good. Depopulated goods are removed from the blockchain in order to prevent an increasing number of goods from “piling up” at a given restaurant.

Access to the blockchain data is used to support multiple business models such as identifying efficient delivery routes that connect multiple producers together, and/or enabling prediction of rates of consumption to enable producers to accurately estimate when and how much to produce. Restaurants/consumers benefit by identifying prices being paid by peers in order to increase their own efficiency.

In some embodiments, the existence of the blockchain is opaque at an application level. That is, some users are not presented with structure of the blockchain and instead submit and view data on a GUI (e.g., through a blockchain explorer application). The blockchain component is operated by a separate class of user as a backend to an application.

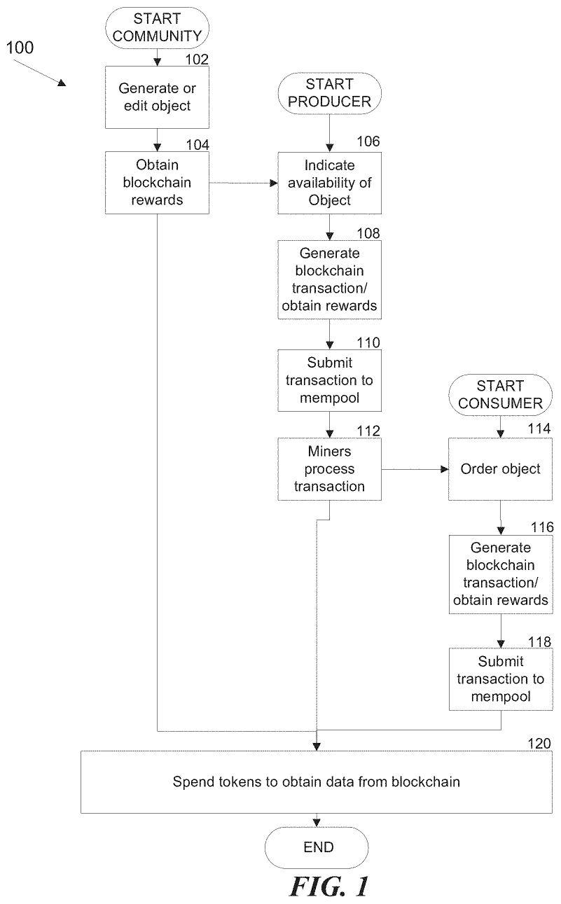

FIG. 1 is a flow chart illustrating a method of integrated blockchain actions with crowd-sourced database actions. In step 102, a member of a crow-sourced database community modifies data within the database. The data published within the database describes objects. The objects include a set of attributes that describe the object. For example, an object may be a consumable good used in a restaurant. Where the object is a carton of mushrooms, the attributes may be the type of mushroom, where they mushrooms came from, the price of the mushrooms, etc.

In some embodiments edits to the crowd-sourced database are performable by verified or otherwise registered users. In those embodiments, registration enables some control over the crowd that is editing the database. The crowd-sourced database includes a change log that enables the functionality to reverse particular changes at a click.

In step 104, the member of the community is granted an amount of tokens connected to the modifications to the crowd-sourced database. In some embodiments, adding new objects is worth a greater number of tokens than editing existing objects. In some embodiments, edits that are subsequently reversed revoked the corresponding tokens from the editing user (or generate token debt for that user).

Given the consumable good example, examples of edits include creating a page for a good, adding an image to an existing good page, adding price and supplier data, adding delivery speed data, adding seasonal data, adding quality data, or adding flavor/texture profile data. In some embodiments, the crowd-sourced database includes specific fields for each object/good in the database. Each fields has a corresponding amount of tokens awarded thereto (e.g., such that some fields are encouraged based on token awards).

The token award corresponds to “mining” in a traditional cryptocurrency network where the user rewards incentivize processing transactions. Here, the incentivized activity is modifying and populating the crowd-sourced database. In some embodiments, the token award is not granted until a threshold number of other users of the crowd-sourced database confirm the edit. Embodiments further include token awards for confirming users. Example user interfaces include querying users for confirmations. Triggering events for confirmation queries include having orders of the relevant good (e.g., because the platform has supplier order data for each restaurant).

In step 106, a producer of objects identifies an object that it has produced via available objects in the crowd-sourced database. For example, the producer may reference the object from step 102. While a producer is referred to, the user may be a distributor, or any user that makes objects available for others. The object includes a number of attributes defined in the crowd-sourced database. In step 108, the object, with its respective attributes are imported into blockchain transaction data. In response to the indication by the producer that the object was created and is available the transaction data is generated by an application platform and the producer is granted a number of tokens based on the disclosure of data to the cryptographic blockchain.

In some embodiments, rather than indicate an amount of the object that is available, the producer merely indicates that some undisclosed amount of the object is available and consumers may obtain that object via transactions (described below) and during those transactions new objects populate into the blockchain.

In step 110, the application platform submits the transaction data to a miner mempool for inclusion into the cryptographic blockchain. Reference to a mempool is described as a single memory; however, in practice the mempool is a collective mempool that exists in the system memory of a plurality of miners operating on the network. Each miner propagates transaction data as received to the mempools of adjacent miners. While the mempool is referenced as a single memory, the actual plurality of mempools may vary in transaction data content based on the rate of propagation about the network. In step 112, the transaction in the mempool along with a set of similar transactions are hashed into blocks that are appended to the cryptographic blockchain.

In step 114, a consumer uses the application platform to order an object. In step 116, in response to the consumer's order, blockchain transaction data is generated to move possession of the object from the producer to the consumer. In addition, the consumer is granted tokens based on disclosing the obtained object from the producer user. In step 118, the transaction data is submitted to the mempool for inclusion into blocks much like in step 110 and 112.

In step 120, any user is enabled by the application platform to spend tokens they have earned (or purchased) to view the data from the blockchain in a human-legible manner (e.g., indexed and searchable via keywords and/or filters via a blockchain explorer).

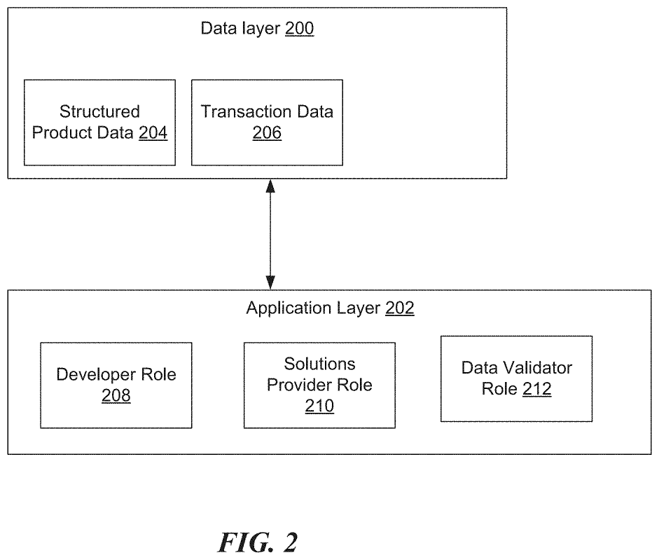

FIG. 2 is a block diagram illustrating a data layer 200 and application layer 202. The data layer 200, includes set of structured product data 204, a high-resolution description of products based on their attributes, ingredients, origins, pack sizes, and dimensions to remove product ambiguity. These characteristics are standardized and surrogate, so they are not specifically associated with a brand. This product layer is based on existing platform classification and attribution taxonomy. The data layer further includes transaction data 206, including dynamic transactions that are effectively contracts that enable the network to see how much product is available, where it is located, whom title belongs, and the timelines associated with the movement of goods.

Data flows in and out of the network from the different ecosystem participants—farms, restaurants, grocers, producers, distributors, manufacturers, importers, agencies, brokers, investors, and the like—via an application layer 202 that serves as a connection. The application layer is the translator between the world of food and the Web 3.0 without requiring the application user's direct involvement in the network.

The application layer 202 plays the role of being the data translator between the participant and the data layer 200. The application layer 202 further breaks down into three primary roles: first, a developer role 208 is a patron that build applications that participating stakeholders finds useful. These applications solve one or many tactical problems for that participant. The developer role leverages the network for data while providing additional value to the stakeholder beyond what is inherently provided by the network.

Second, a solutions provider role 210 is a patron that is responsible for facilitation of various stakeholders onto the network connected application, assuming the participant is not a self-service customer. The solutions provider role helps deploy applications built on the network to the participant business. Third, a data validator role 212 is a patron responsible for verifying and authenticating the accuracy of new or existing information on the network. As applied to a Wiki, the data validator role ensure product and transactional data are reflected properly (e.g., accepting and reversing edits to objects on the Wiki. In some embodiments, one entity performs all three roles, but it is practical and possible for each role to be performed by different entities.

In foodservice today, purchasing contracts are often bilateral, involving two parties in a single transaction of goods, based on the minimum size that can be managed by the entity further up the supply chain. For example, a shrimp farm in Thailand may only be able to export products to California with a minimum unit of a container. In order to facilitate the transaction, an importer (or importing distributor) must be willing to carry the product at their own inventory risk and leverage its own account managers to understand whether the market for the product is available. Furthermore, today these relationships between shrimp farmer and importer are manually managed. Human complexity and risk make it much harder for the shrimp farmer to move product to a market and any distributor participating in the contract must ensure they're willing to carry the initial inventory risk.

Instead, decentralization will enable the shrimp farmer to make contracts available to the end buyers such as restaurants via patron applications. These buyers would be able to indicate their interest in regular orders of shrimp and own a share of the product within the minimum contract (the container). The distributor would be able to elect to fulfill a contract to its customers once at a threshold of guaranteed volume they set. This significantly reduces the risk of carrying a new product for the distributor, creates more purchasing opportunities for buyers at lower prices, and opens new selling markets for producers and manufacturers. On the disclosed network, the minimum volume required to move the shrimp farmer's operations has not changed. However, it is no longer necessary for a single counterpart to take the title of their products in California. In fact, the products are already owned by many end buyers before the shrimp farmer farms. In this case, the distributor is ultimately playing a role as a fulfillment provider, and a business relationship has been established between the parties based on cryptographic rules rather than human relationships. Finally, the fractional ownership model spreads out the burden of risk to many participants, reducing its impact.

Once delivered to the restaurant owners, the tokens representing the shrimp shipment are burned and/or cease movement (e.g., because the restaurant prepares and serves the associated physical shrimp to customers). In embodiments where the tokens representing the shrimp shipment continue to exist, the record serves as a historical record of the transaction.

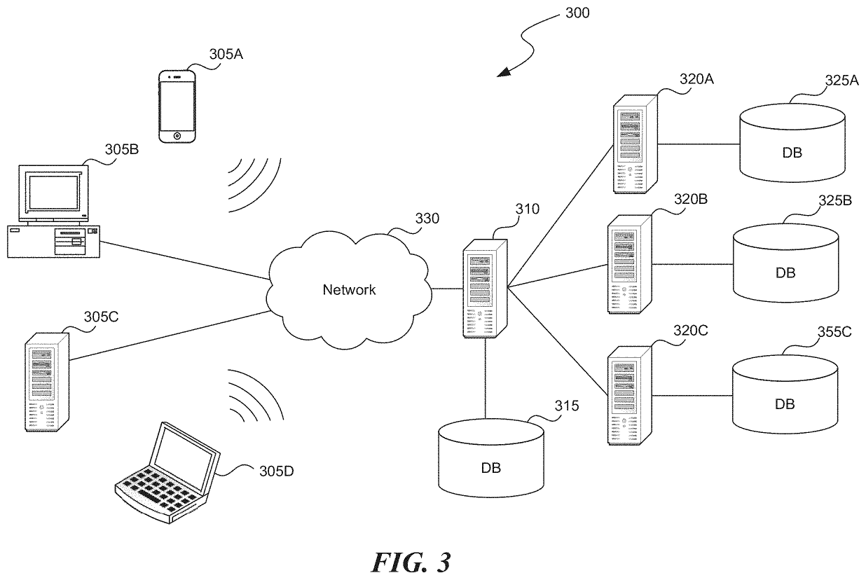

FIG. 3 is a block diagram illustrating an overview of an environment 300 in which some implementations of the disclosed technology can operate. Environment 300 can include one or more client computing devices 305A-D, examples of which can include device 100. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as device 100. Though each server computing device 310 and 320 is displayed logically as a single server, server computing devices can each be a distributed computing environment encompassing multiple computing devices located at the same or at geographically disparate physical locations. In some implementations, each server 320 corresponds to a group of servers.

Client computing devices 305 and server computing devices 310 and 320 can each act as a server or client to other server/client devices. Server 310 can connect to a database 315. Servers 320A-C can each connect to a corresponding database 325A-C. As discussed above, each server 320 can correspond to a group of servers, and each of these servers can share a database or can have their own database. Databases 315 and 325 can warehouse (e.g., store) information such as encryption keys, user addresses, or encryption protocols. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN) or a wide area network (WAN) but can also be other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

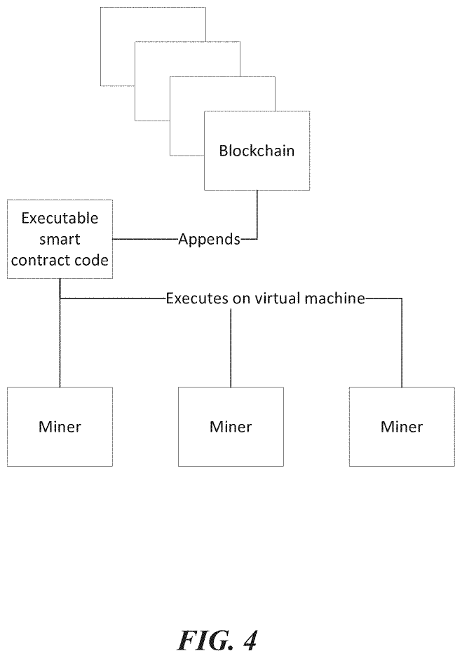

FIG. 4 is a block diagram illustrating a data structure of a smart contract. Smart contracts and dApps execute on an Ethereum virtual machine (“EVM”). The EVM is instantiated on available network nodes. Smart contracts and dApps are applications that execute; thus, the processing power to do so must come from hardware somewhere. Nodes must volunteer their processors to execute these operations based on the premise of being paid for the work in Ethereum coins, referred to as Ether, measured in “gas.” Gas is the name for a unit of work in the EVM. The price of gas can vary, often because the price of Ether varies, and is specified within the smart contract/dApp.

Every operation that can be performed by a transaction or contract on the Ethereum platform costs a certain number of gas, with operations that require more computational resources costing more gas than operations that require few computational resources. For example, at the time of writing, a multiplication instruction requires 5 gas, whereas an addition instruction requires 3 gas. Conversely, more complex instructions, such as a Keccak256 cryptographic hash requires 30 initial gas and 6 additional gas for every 256 bits of data hashed.

The purpose of gas is pay for the processing power of the network on execution of smart contracts at a reasonably steady rate. That there is a cost at all ensures that the work/processing being performed is useful and valuable to someone. Thus, the Ethereum strategy differs from a Bitcoin transaction fee, which is only dependent on the size in kilobytes of a transaction. As a result that Ethereum's gas costs are rooted in computations, even a short segment of code can result in a significant amount of processing performed. The use of gas further enforces incentivizes coders to generate efficient smart contracts/algorithms. Otherwise, the cost of execution may spiral out of control. Unrestricted, an exponential function may bankrupt a given user.

While operations in the EVM have a gas cost, gas has a “gas price” measured in ether. Transactions specify a given gas price in ether for each unit of gas. The fixing of price by transaction enables the market to decide the relationship between the price of ether and the cost of computing operations (as measured in gas). The total fee paid by a transaction is the gas used multiplied by gas price.

If a given transaction offers very little in terms of a gas price, that transaction will have low priority on the network. In some cases, the network miners may place a threshold on the gas price each is willing to execute/process for. If a given transaction is below that threshold for all miners, the process will never execute. Where a transaction does not include enough ether attached (e.g., because the transaction results in so much computational work that the gas costs exceed the attached ether) the used gas is still provided to the miners. When the gas runs out, the miner will stop processing the transaction, revert changes made, and append to the blockchain with a “failed transaction.” Failed transactions may occur because the miners do not directly evaluate smart contracts for efficiency. Miners will merely execute code with an appropriate gas price attached. Whether the code executes to completion or stalls out due to excessive computational complexity is of no matter to the miner.

Where a high gas price is attached to a transaction, the transaction will be given priority. Miners will process transactions in order of economic value. Priority on the Ethereum blockchain works similarly as with the Bitcoin blockchain. Where a user attaches more ether to a given transaction than necessary, the excess amount is refunded back to that user after the transaction is executed/processed. Miners only charge for the work that is performed. A useful analogy regarding gas costs and price is that the gas price is similar to an hourly wage for the miner, whereas the gas cost is like a timesheet of work performed.

A type of smart contract that exists on the Ethereum blockchain are ERC-20 tokens (Ethereum Request for Comment-20). ERC-20 is a technical specification for fungible utility tokens. ERC-20 defines a common list of rules for Ethereum tokens to follow within the larger Ethereum ecosystem, allowing developers to accurately predict interaction between tokens. These rules include how the tokens are transferred between addresses and how data within each token is accessed. ERC-20 provides a framework for a means to build a token on top of a base cryptocurrency. In some embodiments herein, enhancements are built on top of the ERC-20 framework, though use of the ERC-20 technical specification is not inherently necessary and is applicable to circumstances where Ethereum is used as the base cryptocurrency. In some embodiments, the ERC-20 token specification is implemented to serve as the cryptographic tokens that are minted and burned in response to providing and extracting data from the disclosed platform. However, other custom tokens on non-Ethereum blockchains are also potential implementations.

Another type of smart contract that exists on the Ethereum blockchain are ERC-721 tokens (Ethereum Request for Comment-721). ERC-721 is a technical specification for NFTs. The ERC-721 introduces a standard for NFT. An ERC-721 token is unique and can have different exclusivity to another token from the same smart contract, maybe due to age, rarity or visuals.

NFTs have a uint256 variable called tokenId. Thus, for any ERC-721 contract, the pair contract address, uint256 tokenId must be globally unique. That said, a given dApp can have a “converter” that uses the tokenId as input and outputs an image. In some embodiments, the ERC-721 tokens specification is implemented to serve as the cryptographic record of a specific food product as transmitted between various users. However, other custom tokens on non-Ethereum blockchains are also potential implementations.

Disclosure on token protocols has focused on Ethereum. As applicable in this disclosure, this are base cryptocurrencies. Other base cryptocurrencies exist now and in the future. This disclosure is not limited to application on specifically the Bitcoin or Ethereum blockchains.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1. A method of moderating a page of a crowd-sourced Wiki via blockchain tracked cryptographic tokens comprising:
receiving edited content by the page of the crowd-sourced Wiki from a first user, the first user identified by a first cryptographic identifier tracked by a blockchain data structure;
publishing the edited content by the page; and
based on said publishing the edited content by the page of the crowd-sourced Wiki, minting a first predetermined number of cryptographic tokens as linked to the first cryptographic identifier of the first user.

2. The method of claim 1, further comprising:
receiving a content request of the page of the crowd-sourced Wiki by a second user;
in response to said receiving the content request, burning a second predetermined amount of cryptographic tokens linked to a second cryptographic identifier identifying the second user; and
in response to said burning, transmitting requested content of the page of the crowd-sourced Wiki to the second user.

3. The method of claim 1, wherein a condition of said publishing is that the edited content must first be confirmed by a user other than the first user.

4. The method of claim 3, wherein the edited content must first be confirmed by a predetermined set of users other than the first user.

5. The method of claim 1, wherein said minting is further based on the edited content remaining unchanged for a predetermined period of time.

6. The method of claim 1, wherein the edited content refers to a physical good, the method further comprising:
receiving, by the blockchain data structure from a second user, an indicator of availability of a first object associated with the page of the crowd-sourced Wiki; and
recording, on the blockchain data structure to a second cryptographic identifier associated with the second user, a link of the first object to the second user.

7. The method of claim 6, further comprising:
receiving, by a blockchain explorer application, a search query of the blockchain data structure by a third user, wherein the search query seeks requested search results indicating the availability and the links of the first object;
in response to said receiving the search query, burning a second predetermined amount of cryptographic tokens linked to a third cryptographic identifier identifying the third user; and
in response to said burning, transmitting requested search results of the blockchain data structure to the third user.

8. The method of claim 6, further comprising:
based on said recording the link of the first object to the second user, minting a second predetermined number of cryptographic tokens as linked to the second cryptographic identifier of the second user.

9. The method of claim 6, further comprising:
executing a cryptographic transaction that shifts the link of the first object from the second user to a third user or a set of users.

10. A system of moderating a page of a crowd-sourced Wiki via blockchain tracked cryptographic tokens comprising:
a database including a memory that stores the crowd-sourced Wiki;
a network interface configured to receive edited content associated with the page of the crowd-sourced Wiki from a first user, the first user identified by a first cryptographic identifier tracked by a blockchain data structure; and
a processor implemented host server configured to publish the edited content by the page and based on said publishing the edited content by the page of the crowd-sourced Wiki, issue a command to a smart contract that mints a first predetermined number of cryptographic tokens as linked to the first cryptographic identifier of the first user.

11. The system of claim 10, the network interface further configured to receive a content request of the page of the crowd-sourced Wiki by a second user;
in response to said receiving the content request, the processor implemented host server is configured to issue instructions to the smart contract burn a second predetermined amount of cryptographic tokens linked to a second cryptographic identifier identifying the second user; and
in response to said burning, the network interface further configured to transmit the requested content of the page of the crowd-sourced Wiki to the second user.

12. The system of claim 10, wherein a condition of said publishing is that the edited content must first be confirmed by a user other than the first user.

13. The system of claim 12, wherein the edited content must first be confirmed by a predetermined set of users other than the first user.

14. The system of claim 10, wherein said minting is further based on the edited content remaining unchanged for a predetermined period of time.

15. The system of claim 10, wherein the edited content refers to a physical good, wherein the network interface is further configured to receive an indicator from a second user of availability of a first object associated with the page of the crowd-sourced Wiki to record on the blockchain data structure and to generate a transaction on the blockchain data structure that links a second cryptographic identifier associated with the second user to the first object.

16. The system of claim 15, wherein the network interface is further configured to receive, and relay to a blockchain explorer application, a search query of the blockchain data structure by a third user, wherein the search query seeks requested search results indicating the availability and the links of the first object;
wherein the processor implemented host server is further configured trigger the smart contract to burn a second predetermined amount of cryptographic tokens linked to a third cryptographic identifier identifying the third user in response to receipt of the search query, and wherein the processor implemented host server is further configured to transmit the requested search results of the blockchain data structure to the third user in response to said burning.

17. The system of claim 15, wherein the smart contract is configured to mint a second predetermined number of cryptographic tokens as linked to the second cryptographic identifier of the second user based on said link of the first object to the second user.

18. The system of claim 15, wherein a blockchain network associated with the smart contract is configured to execute a cryptographic transaction that shifts the link of the first object from the second user to a third user or a set of users.

19. A method of moderating a page of a crowd-sourced Wiki via blockchain tracked cryptographic tokens comprising:
receiving edited content by the page of the crowd-sourced Wiki from a first user, the first user identified by a first cryptographic identifier tracked by a blockchain data structure;
publishing the edited content by the page;
based on said publishing the edited content by the page of the crowd-sourced Wiki, minting a first predetermined number of cryptographic tokens as linked to the first cryptographic identifier of the first user;
receiving, by a smart contract from a second user, an indicator of availability of a first object associated with the page of the crowd-sourced Wiki, the smart contract maintained on the blockchain data structure;
recording, on the blockchain data structure to a second cryptographic identifier associated with the second user, a link of the first object to the second user and a second predetermined number of cryptographic tokens newly minted as linked to the second cryptographic identifier of the second user;
receiving, by a blockchain explorer application, a search query of the blockchain data structure by a third user, wherein the search query seeks requested search results indicating the availability and the links of the first object;
in response to said receiving the search query, burning a second predetermined amount of cryptographic tokens linked to a third cryptographic identifier identifying the third user; and
in response to said burning, transmitting requested search results of the blockchain data structure to the third user.

20. The method of claim 19, wherein a condition of said publishing is that the edited content must first be confirmed by a user other than the first user.

21. The method of claim 20, wherein the edited content must first be confirmed by a predetermined set of users other than the first user.

22. The method of claim 19, wherein said minting is further based on the edited content remaining unchanged for a predetermined period of time.

23. The method of claim 19, further comprising:
executing a cryptographic transaction that shifts the link of the first object from the second user to a third user or a set of users.
